(19) United States
(12) Patent Application Publication
(10) Pub. No.: US 2026/0042291 A1
(43) Pub. Date: Feb. 12, 2026

(54) LIQUID EJECTION HEAD SUBSTRATE, LIQUID EJECTION HEAD, AND METHOD OF MANUFACTURING LIQUID EJECTION HEAD SUBSTRATE

(71) Applicant: CANON KABUSHIKI KAISHA, Tokyo (JP)

(72) Inventors: SADAYOSHI SAKUMA, Kanagawa (JP); TOSHIO NEGISHI, Kanagawa (JP)

(21) Appl. No.: 19/259,294

(22) Filed: Jul. 3, 2025

(30) Foreign Application Priority Data
Aug. 7, 2024 (JP) 2024-130833

(51) Int. Cl. B41J 2/14; B41J 2/16

(52) U.S. Cl. CPC B41J 2/1408; B41J 2/14072; B41J 2/14129; B41J 2/1601; B41J 2/164

(57) ABSTRACT

A liquid ejection head substrate includes a first wiring layer, an insulation layer covering the first wiring layer, a resistance heating element formed on a surface of the insulation layer on an opposite side of the first wiring layer, a second wiring layer formed at a different portion from the resistance heating element on the surface of the first wiring layer, a first protection layer having an insulating property and covering the resistance heating element and the second wiring layer, and a second protection layer formed to overlap the first protection layer. The second protection layer includes a heating element side electrode portion overlapping a portion of the first protection layer covering the resistance heating element, and a counter electrode portion located away from the heating element side electrode portion and overlapping a portion of the first protection layer covering the second wiring layer.

### BACKGROUND

### Field of the Technology

The present disclosure relates to a liquid ejection head substrate, a liquid ejection head, and a method of manufacturing a liquid ejection head substrate.

### Description of the Related Art

A thermal ink jet printing apparatus represents an example of a liquid ejection apparatus. The thermal ink jet printing apparatus can perform printing at high speed and with high quality by forming an ink into bubbles by using thermal energy. Meanwhile, the thermal ink jet printing apparatus is suitable for colorization and compactification. A liquid ejection head mounted on the ink jet printing apparatus is also referred to as a print head. The print head includes multiple ejection nozzles, channels communicating with the ejection nozzles, and electrothermal transducing elements that generate thermal energy used for ejecting an ink. An electrothermal transducing element is provided with a heat generating portion and an electrode wiring layer that supplies electric power to the heat generating portion. The electrothermal transducing element feeds an electric current to the heat generating portion to cause the heat generating portion to generate the thermal energy, thus heating the ink in the channel so as to bring about film-boiling. The print head ejects ink droplets from each ejection nozzle by using a pressure of volume expansion associated with bubble formation due to the film-boiling.

A heat-soluble ink component is decomposed or denatured by the heat generated by the heat generating portion, and adheres to a protection film covering the heat generating portion as impurities. The impurities that adheres to the protection film covering the heat generating portion is referred kogation. In the case where the kogation adheres to the protection film covering the heat generating portion, thermal conductivity from the heat generating portion to the ink is reduced whereby bubble formation with the ink and an ink ejecting operation become unstable. In this regard, Japanese Patent Laid-Open No. 2008-105364 discloses a technique for removing a kogation by forming an upper protection layer on a surface of a protection layer (a protecting film) covering a heat generating portion by use of a material such as iridium which is soluble by an electrochemical reaction, and dissolving the upper protection layer by using the electrochemical reaction. In this instance, a region on the heat generating portion side of the upper protection layer located in the vicinity of the heat generating portion will be defined as one electrode, while a region on a counter electrode side of the upper protection layer located away from the region on the heat generating portion side thereof will be defined as another electrode. Then, the region on the heat generating portion side of the upper protection layer is eluted into an ink due to the electrochemical reaction by applying a voltage to both of the electrodes, thereby removing a kogation adhering to the region on the heat generating portion side of the upper protection layer.

The region on the heat generating portion side of the upper protection layer and the region on the counter electrode side of the upper protection layer are formed by subjecting the upper protection layer to dry etching, for example. A noble metal such as iridium and ruthenium used as the material of the upper protection layer is a material that can be hardly etched by a chemical reaction. For this reason, a method of removal close to physical sputtering by ions is used as the method of subjecting the upper protection layer to dry etching.

### SUMMARY

An object of the present disclosure is to enable reliable removal of a kogation generated on a liquid ejection head substrate.

A liquid ejection head substrate according to an aspect of the present disclosure includes a first wiring layer for supplying electric power, an insulation layer covering the first wiring layer, a resistance heating element formed on a surface of the insulation layer on an opposite side of the first wiring layer and configured to generate thermal energy for ejecting a liquid by the electric power supplied from the first wiring layer, a second wiring layer formed at a different portion from the resistance heating element on the surface of the insulation layer on the opposite side of the first wiring layer and electrically connected to the first wiring layer, a first protection layer having an insulation property and covering the resistance heating element and the second wiring layer, and a second protection layer formed to overlap the first protection layer. The second protection layer includes a heating element side electrode portion configured to overlap a portion of the first protection layer covering the resistance heating element, and a counter electrode portion located away from the heating element side electrode portion and configured to overlap a portion of the first protection layer covering the second wiring layer.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view of an ink jet printing apparatus;

FIG. 2 is a perspective view of a liquid ejection head;

FIG. 3 is a block diagram showing a control system of the ink jet printing apparatus;

FIG. 4 is a plan view schematically showing a comparative example of an element substrate;

FIGS. 5A and 5B are cross-sectional views schematically showing the comparative example of the element substrate;

FIGS. 6A and 6B are diagrams schematically showing an element substrate according to a first embodiment;

FIGS. 7A to 7D are schematic cross-sectional views for explaining manufacturing steps of the element substrate;

FIGS. 8A to 8C are schematic cross-sectional views for explaining the manufacturing steps of the element substrate; and

FIGS. 9A and 9B are diagrams schematically showing an element substrate according to a second embodiment.

### DESCRIPTION OF THE EMBODIMENTS

Preferred embodiments of the present disclosure will be described below in detail with reference to the accompanying drawings. It is to be noted that the following embodiments are not intended to limit the subject matter of the present disclosure and that all combinations of features described in the following embodiments are not always essential to a solution of the present disclosure. Here, the same components will be described by denoting the same reference numerals.

### First Embodiment

### <Configuration of Liquid Ejection Apparatus>

A description will be given of a liquid ejection head using a liquid ejection head substrate according to the present embodiment and a liquid ejection apparatus including the liquid ejection head. In the present embodiment, a thermal ink jet printing apparatus will be described as an example of the liquid ejection apparatus. In the present embodiment, the term “printing” may include not only a case of forming a visible object such as an image, a design, a pattern, and a structure on a printing medium so as to be visually perceivable to humans, but also a case of processing a medium. The “printing medium” may include not only paper used in a general liquid ejection apparatus but also a material that can accept attachment of a printing agent as typified by a cloth, a plastic film, a metal plate, glass, a ceramic, wood, and leather. The “printing agent” may include not only a liquid such as an ink to be attached to the printing medium and to serve for formation of the image, the design, the pattern, and the like or for processing of the printing medium, but also a liquid to serve for processing of the printing agent (coagulation or insolubilization of a coloring material contained in the printing agent, for instance).

Note that the liquid ejection apparatus is not limited to the ink jet printing apparatus. For example, the liquid ejection apparatus may be a single function printer having a printing function only, or a multifunction printer having multiple functions including the printing function, a facsimile function, a scanning function, and so forth. The liquid ejection apparatus may be a manufacturing apparatus for manufacturing color filters, electronic devices, optical devices, microstructures, and the like in accordance with prescribed printing methods, for example.

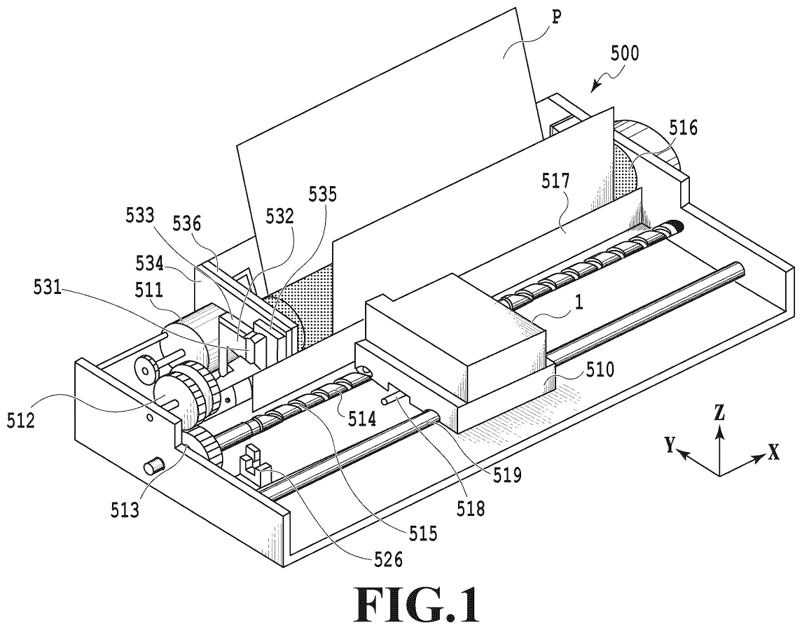

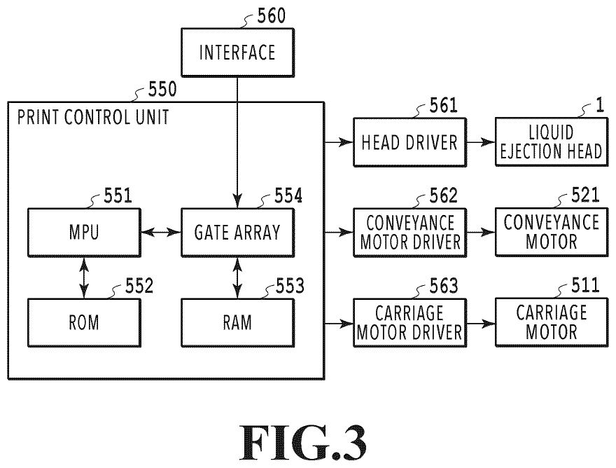

FIG. 1 is a perspective view of an ink jet printing apparatus 500. In FIG. 1, z direction indicates a vertical direction which intersects (at right angle in the case of the present embodiment) with x-y plane defined by x direction and y direction. As shown in FIG. 1, the ink jet printing apparatus 500 includes a liquid ejection head 1, a carriage 510, a photo-coupler 526, a cap member 531, and a cleaning blade 535. The liquid ejection head 1 is mounted on an upper side of the carriage 510. The carriage 510 is engaged with a helical groove 515 of a lead screw 514. The carriage 510 moves in the x direction along a guide 519 in association with rotation of the lead screw 514. The lead screw 514 is connected to a carriage motor 511 through multiple driving force transmission gears 512 and 513. The lead screw 514 is rotated by transmitting driving force from the carriage motor 511 to the lead screw 514 through the multiple driving force transmission gears 512 and 513. Accordingly, the liquid ejection head 1 can reciprocally move in the x direction (a main scanning direction) together with the carriage 510 by the driving force of the carriage motor 511. Printing paper P serving as a printing medium is conveyed onto a platen 516 by a printing medium feeding device (not shown). A paper pressing plate 517 presses the printing paper P against the platen 516 along a direction of movement (the x direction) of the carriage 510. Here, the printing medium feeding device is driven by a conveyance motor 521 (see FIG. 3).

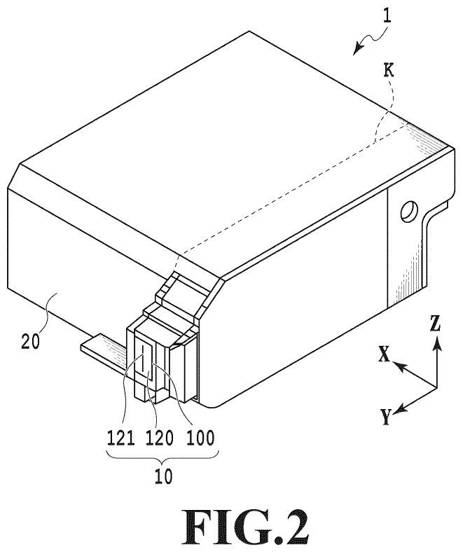

The photo-coupler 526 detects a lever 518 provided to the carriage 510, thereby detecting movement of the carriage 510 to a home position. The cap member 531 is supported by a support member 532 in such a way as to be located in the vicinity of the home position. The cap member 531 caps a surface (an ejection nozzle surface) provided with ejection nozzles 121 (see FIG. 2) of the liquid ejection head 1 in a case where the carriage 510 moves to the home position. A suction-based recovery mechanism 533 performs suction recovery of the liquid ejection head 1 by suctioning the inside of the cap member 531. The cleaning blade 535 is disposed in the vicinity of the cap member 531 and configured to clean the ejection nozzle surface of the liquid ejection head 1. A moving member 534 moves the cleaning blade 535 in an anteroposterior direction (the y direction). The cleaning blade 535 and the moving member 534 are supported by a main body support board 536. Here, the cleaning blade 535 is not limited to the aspect shown in FIG. 1 and a cleaning board of a well-known mode may be applied thereto instead. Meanwhile, a print control unit 550 (see FIG. 3) is provided to a main body (not shown) of the ink jet printing apparatus 500. The print control unit 550 performs drive control of the liquid ejection head 1, the carriage motor 511, the conveyance motor 521, and so forth.

In the ink jet printing apparatus 500 having the above-described configuration, the liquid ejection head 1 performs printing on the printing paper P being conveyed onto the platen 516 by the printing medium feeding device (not shown) while reciprocally moving across the entire width of the printing paper P. The liquid ejection head 1 adopting the liquid ejection head substrate according to the present embodiment can carry out printing at high speed and with high image quality.

### <Configuration of Liquid Ejection Head>

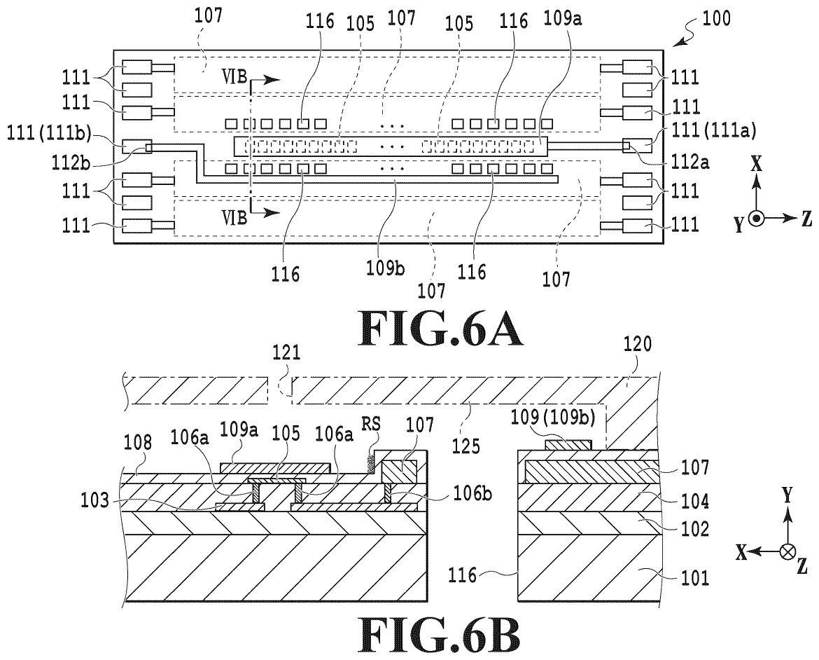

FIG. 2 is a perspective view of the liquid ejection head 1 adopting the liquid ejection head substrate according to the present embodiment. Note that the liquid ejection head substrate will be referred to as an element substrate 100 (see FIGS. 6A and 6B) in the following description. The liquid ejection head 1 includes a printing unit 10 and an ink container 20 that holds an ink to be supplied to the printing unit 10. The printing unit 10 includes the element substrate 100 and a channel forming member 120. Details of the element substrate 100 will be described later. The channel forming member 120 is joined to a surface on one side (+y direction side) of the element substrate 100. The channel forming member 120 includes multiple ejection nozzles 121 formed at positions corresponding to resistance heating elements 105 (see FIG. 6A) of the element substrate 100. The channel forming member 120 forms liquid channels 125 between the channel forming member 120 and the element substrate 100 in such a way as to communicate with ink supply ports 116 and the ejection nozzles 121, which are formed to penetrate the element substrate 100 (see FIG. 6B). The ink container 20 is detachably attached to the printing unit 10 by using a borderline K as a boundary. A fibrous or porous ink absorber is provided inside the ink container 20, and the ink is held by this ink absorber. The liquid ejection head 1 ejects ink droplets in the +y direction from the ejection nozzles 121 toward the printing paper P in a state of being mounted on the carriage 510. Meanwhile, the liquid ejection head 1 is provided with electric contacts (not shown) for receiving electric signals (print data) from the print control unit 550 (see FIG. 3) in the state where the liquid ejection head 1 is mounted on the carriage 510. The resistance heating elements 105 provided to the element substrate 100 of the liquid ejection head 1 generate heat based on the electric signals received through the electric contacts.

Here, the liquid ejection head 1 shown in FIG. 2 is a so-called serial ink jet head configured to eject the ink while moving in the main scanning direction. However, the liquid ejection head is not limited to this configuration. The print head may be a so-called full-line ink jet head that can eject the ink across the entire region in the width direction of the printing paper P without moving in the main scanning direction.

### <Control System of Liquid Ejection Apparatus>

Next, a control system of the ink jet printing apparatus 500 (the liquid ejection apparatus) will be described. FIG. 3 is a block diagram showing the control system of the ink jet printing apparatus 500. As shown in FIG. 3, the ink jet printing apparatus 500 further includes the print control unit 550, an interface 560, a head driver 561, a conveyance motor driver 562, and a carriage motor driver 563. The print control unit 550 includes a micro-processing unit (MPU) 551, a program read only memory (ROM) 552, a random access memory (RAM) 553, and a gate array 554. In the meantime, the interface 560 that accepts input of a print signal, the head driver 561, the conveyance motor driver 562, and the carriage motor driver 563 are electrically connected to the print control unit 550. The program ROM 552 stores a control program to be executed by the MPU 551. The dynamic RAM 553 saves various data including the print signal inputted to the interface 560, the print data to be transferred to the liquid ejection head 1, and the like. The gate array 554 performs data transfer control of the print data to the head driver 561. The gate array 554 also performs data transfer control among the interface 560, the MPU 551, and the RAM 553. The head driver 561 drives the liquid ejection head 1 in accordance with the print data sent from the print control unit 550. The conveyance motor driver 562 drives the conveyance motor 521 in accordance with a drive signal sent from the print control unit 550. The carriage motor driver 563 drives the carriage motor 511 in accordance with a drive signal sent from the print control unit 550.

In the case where the print signal is inputted to the interface 560, the print signal is converted between the gate array 554 and the MPU 551 into the print data used for printing. Then, the liquid ejection head 1 is driven in accordance with the print data sent to the head driver 561, and the printing is performed on the printing paper P. In this instance, the conveyance motor 521 is driven in accordance with the drive signal sent to the conveyance motor driver 562, and the carriage motor 511 is driven in accordance with the drive signal sent to the carriage motor driver 563.

### <Comparative Example of Liquid Ejection Head Substrate>

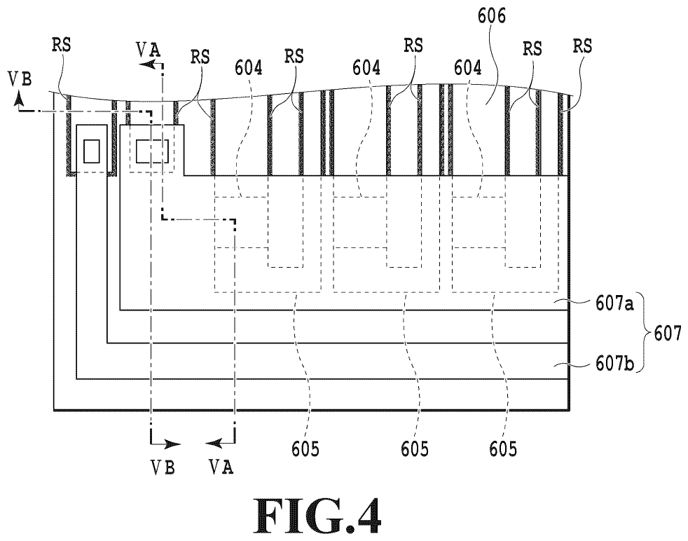

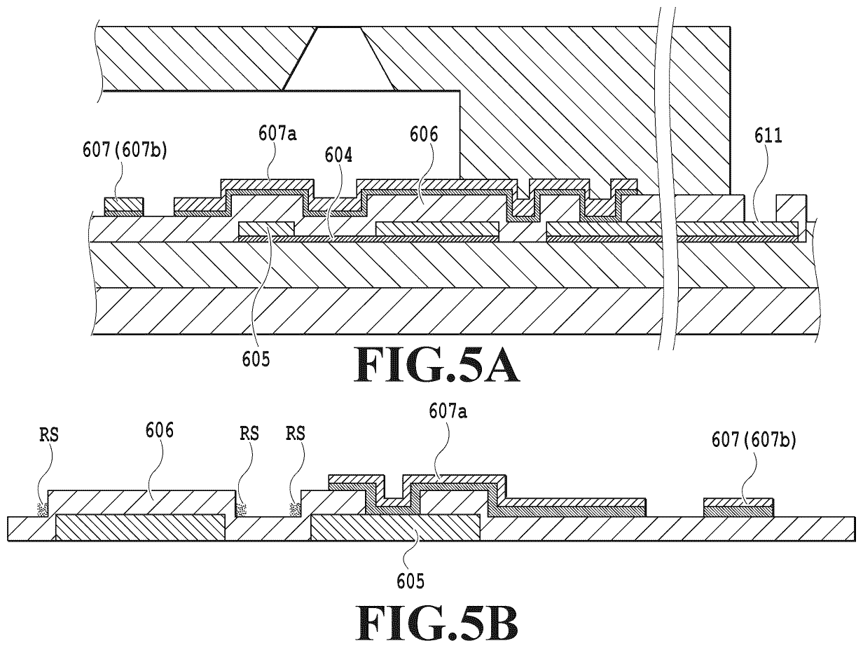

Next, a comparative example of the element substrate (the liquid ejection head substrate) will be described. FIG. 4 is a plan view schematically showing the comparative example of the element substrate. FIGS. 5A and 5B are cross-sectional views schematically showing the comparative example of the element substrate. FIG. 5A is a schematic cross-sectional view taken along the VA-VA line in FIG. 4. FIG. 5B is a schematic cross-sectional view taken along the VB-VB line in FIG. 4. Note that the x, y, and z directions in FIGS. 4 to 9B coincide with the x, y, and z directions in FIG. 1 in the case where the liquid ejection head 1 is mounted on the carriage 510. In the case where the liquid ejection head 1 is not mounted on the carriage 510, directions of the liquid ejection head 1 and the element substrate 100 can be freely changed. For example, the directions of the liquid ejection head 1 and the element substrate 100 can be changed such that the element substrate 100 and the channel forming member 120 (the ejection nozzles 121) are directed upward.

As shown in FIGS. 4 and 5A, the element substrate of the comparative example includes heat generating portions 604 serving as electrothermal transducing elements, electrode wiring layers 605, a protection layer 606, and an upper protection layer 607. The electrode wiring layers 605 supply electric power to the heat generating portions 604. An external electrode 611 is formed at a tip of each electrode wiring layer 605. The protection layer 606 covers surfaces of the heat generating portions 604 and the electrode wiring layers 605 by using an insulating material such as a silicon nitride film. The upper protection layer 607 is formed by using a metallic material such as iridium and in such a way as to overlap the protection layer 606. Meanwhile, the upper protection layer 607 includes a region 607a on the heat generating portion side located in the vicinity of the heat generating portions 604, and a region 607b on a counter electrode side located away from the region 607a on the heat generating portion side. The protection layer 606 is provided with steps based on shapes of the electrode wiring layers 605.

As mentioned earlier, the noble metal such as iridium used as the material of the upper protection layer 607 is the material that is hardly etchable. If there is a step at a portion to be removed by dry etching in the course of carrying out the dry etching on the upper protection layer 607, a conductive residue may be generated at a side wall portion of the step by an etched material (the upper protection layer 607) which is not removed by the dry etching. For example, in the case of carrying out the dry etching on the upper protection layer 607, conductive residues RS may be generated at side wall portions of steps of the protection layer 606 in regions where the upper protection layer 607 are removed as shown in FIGS. 4 and 5B. Meanwhile, the conductive residues RS may be generated at the side wall portions of the steps due to re-adhesion of a reaction product of the etched material (the upper protection layer 607) removed from a flat portion. In these cases, the region 607a on the heat generating portion side of the upper protection layer 607 is likely to be electrically connected to the region 607b on the counter electrode side thereof through the conductive residues RS generated at the side wall portions of the protection layer 606. In the case where the region 607a on the heat generating portion side of the upper protection layer 607 is electrically connected to the region 607b on the counter electrode side thereof, a potential difference is generated between the region 607a on the heat generating portion side and the region 607b on the counter electrode side, which will complicate removal of a kogation. Meanwhile, if layout design is conducted in such a way as to keep each of the region 607a on the heat generating portion side of the upper protection layer 607 and the region 607b on the counter electrode side thereof from crossing the step of the protection layer 606, this operation may possibly deteriorate design freedom concerning arrangement of the heat generating portions 604, the liquid channels, and the like. In the present embodiment, a description will be given of a configuration that enables reliable removal of a kogation generated on the element substrate.

### <Configuration of Liquid Ejection Head Substrate>

Next, the element substrate 100 (the liquid ejection head substrate) according to the first embodiment will be described. FIGS. 6A and 6B are diagrams schematically showing the element substrate 100 according to the first embodiment. FIG. 6A is a plan view schematically showing the element substrate 100. FIG. 6B is a schematic cross-sectional view taken along the VIB-VIB line in FIG. 6A.

As shown in FIGS. 6A and 6B, the element substrate 100 includes a silicon substrate 101, a heat accumulation layer 102, a first wiring layer 103, an insulation layer 104, the resistance heating elements 105, and a second wiring layer 107. Moreover, the element substrate 100 includes a heat generation connecting member 106a, a wiring connecting member 106b, a first protection layer 108, and a second protection layer 109. As shown in FIG. 6B, the silicon substrate 101 is formed into a plate-like shape by using silicon (Si) and the like. The heat accumulation layer 102 is formed to overlap a surface on one side (the +y direction side) of the silicon substrate 101 by using a thermally oxidized film, a SiO film, a SiN film, or the like.

As shown in FIG. 6B, the first wiring layer 103 is formed by using a material containing a metal such as aluminum (Al) and in such a way as to overlap a surface on one side of the heat accumulation layer 102. The first wiring layer 103 and the second wiring layer 107 form wiring for supplying electric power to the resistance heating elements 105. The insulation layer 104 is formed on a surface on the one side of the heat accumulation layer 102 by using an insulator such as a silicon oxide film and in such a way as to cover the first wiring layer 103. Accordingly, the first wiring layer 103 is buried in the insulation layer 104 and a surface on one side of the insulation layer 104, or in other words, a surface of the insulation layer 104 on an opposite side of the first wiring layer 103 is formed flat.

The resistance heating elements 105 are formed on the one side of the insulation layer 104, or in other words, the surface of the insulation layer 104 on the opposite side of the first wiring layer 103 by using a compound of tantalum (Ta) such as TaSiN (tantalum silicon nitride). The resistance heating elements 105 are electrically connected to the first wiring layer 103 through the heat generation connecting member 106a, and the electric power is supplied thereto from the first wiring layer 103. The resistance heating elements 105 generate thermal energy used for ejecting the ink. As shown in FIG. 6A, the multiple resistance heating elements 105 are arranged in one line in a longitudinal direction (the z direction) at a central part of the element substrate 100. Meanwhile, the multiple ink supply ports 116 are arranged in two lines in the longitudinal direction beside two sides (±x direction sides) of the multiple resistance heating elements 105.

As shown in FIG. 6B, the second wiring layer 107 is formed at a portion on the surface on the one side of the insulation layer 104 located away in the x direction from the resistance heating elements 105 by using the same material as that of the first wiring layer 103. In other words, the second wiring layer 107 is formed at a portion on the surface of the insulation layer 104 being located on the opposite side of the first wiring layer 103 and different from the resistance heating elements 105. The second wiring layer 107 is electrically connected to the first wiring layer 103 through the wiring connecting member 106b. Meanwhile, a thickness of the second wiring layer 107 is larger than a thickness of the resistance heating elements 105.

The second wiring layer 107 forms power supply wiring and ground wiring, respectively, beside two sides (the ±x direction sides) of the multiple resistance heating elements 105 (see FIG. 6A). As described above, the second wiring layer 107 forms solid pattern wiring that spreads in a wide range on the element substrate 100. Accordingly, it is possible to reduce wiring resistance of the second wiring layer 107 while suppressing an increase in size of the element substrate 100.

Here, one of electrodes provided to each resistance heating element 105 is electrically connected to the second wiring layer 107 that extends in the longitudinal direction on a near side to the resistance heating element 105 through the heat generation connecting member 106a, the first wiring layer 103, and the wiring connecting member 106b. The second wiring layer 107 to be linked to the one electrode of the resistance heating element 105 forms the power supply wiring for supplying the electric power from the outside of the element substrate 100 to the resistance heating element 105. The second wiring layer 107 that forms the power supply wiring extends to an end portion in the longitudinal direction of the element substrate 100, and is electrically connected to a certain electrode pad 111 out of multiple electrode pads 111 provided at end portions on both sides of the element substrate 100. Here, the electrode pads 111 are electrically connected to the outside of the element substrate 100 (the liquid ejection head 1). The electrode pads 111 are formed by gold plating and the like on a surface of an end portion of a wiring layer that uses aluminum and the like.

Another electrode provided to the resistance heating element 105 is electrically connected to a driving circuit (not shown) formed on the silicon substrate 101 through the heat generation connecting member 106a and the first wiring layer 103. The driving circuit selectively drives a certain resistance heating element 105 out of the multiple resistance heating elements 105. The driving circuit is electrically connected to the second wiring layer 107 extending in the longitudinal direction on a far side from the resistance heating elements 105 through a circuit connecting member (not shown) formed to penetrate the insulation layer 104. The second wiring layer 107 linked to the driving circuit forms the ground wiring. The second wiring layer 107 that forms the ground wiring extends to the end portion in the longitudinal direction of the element substrate 100 and is electrically connected to a certain electrode pad 111 out of the multiple electrode pads 111 provided at the end portions on both sides of the element substrate 100.

As shown in FIG. 6B, the heat generation connecting member 106a is formed to penetrate the insulation layer 104 and configured to electrically connect the first wiring layer 103 to the resistance heating elements 105. The wiring connecting member 106b is formed to penetrate the insulation layer 104 and configured to electrically connect the first wiring layer 103 to the second wiring layer 107. Meanwhile, the aforementioned circuit connecting member (not shown) is formed to penetrate the insulation layer 104 and configured to electrically connect the aforementioned driving circuit to the second wiring layer 107. The heat generation connecting member 106a, the wiring connecting member 106b, and the circuit connecting member are each formed by using a material containing tungsten (W), for example, into a plug shape that closes a hole (not shown) formed to penetrate the insulation layer 104.

The first protection layer 108 is formed on the surface on the one side of the insulation layer 104 by using a material having an insulation property such as a silicon nitride film and in such a way as to cover the resistance heating elements 105 and the second wiring layer 107. The first protection layer 108 functions as a protection film for protecting the resistance heating elements 105 and the second wiring layer 107 from liquids such as the ink.

The second protection layer 109 is formed to overlap a surface on one side of the first protection layer 108. The second protection layer 109 is formed by using a material containing a metal such as iridium (Ir) to be eluted into the ink due to an electrochemical reaction. The second protection layer 109 includes a heating element side electrode portion 109a and a counter electrode portion 109b. The heating element side electrode portion 109a is formed to overlap a portion of the first protection layer 108 covering the resistance heating elements 105. The counter electrode portion 109b is formed to overlap a portion of the first protection layer 108 covering the second wiring layer 107, and is located away from the heating element side electrode portion 109a. The heating element side electrode portion 109a is eluted into the ink due to the electrochemical reaction in the course of a cleaning treatment in order to remove the kogation.

The heating element side electrode portion 109a extends to the end portion in the longitudinal direction of the element substrate 100, and is electrically connected to a certain electrode pad 111 out of the multiple electrode pads 111 provided at the end portions on both sides of the element substrate 100. Such an electrode pad 111a linked to the heating element side electrode portion 109a is electrically connected to an end portion of the heating element side electrode portion 109a through a metallic member 112a using a metallic material being different from the material of the second protection layer 109. The counter electrode portion 109b extends to the end portion in the longitudinal direction of the element substrate 100, and is electrically connected to a certain electrode pad 111 out of the multiple electrode pads 111 provided at the end portions on both sides of the element substrate 100. Such an electrode pad 111b linked to the counter electrode portion 109b is electrically connected to an end portion of the counter electrode portion 109b through the metallic member 112b using a metallic material being different from the material of the second protection layer 109. For example, the metallic materials used for the metallic members 112a and 112b contain gold (Au) and the like. Accordingly, even in the case where the second protection layer 109 for removing the kogation is formed by using the material containing iridium and the like, the heating element side electrode portion 109a and the counter electrode portion 109b can easily be connected to the electrode pads 111. Here, the metallic members 112a and 112b may be metallic films formed by plating and the like.

Meanwhile, since the heating element side electrode portion 109a is formed to extend along the direction of arrangement of the multiple resistance heating elements 105, the single electrode pad 111a to be linked to the heating element side electrode portion 109a can be used in common. Since the counter electrode portion 109b is formed to extend along the direction of arrangement of the multiple resistance heating elements 105, the single electrode pad 111b to be linked to the counter electrode portion 109b can be used in common.

As mentioned earlier, the channel forming member 120 is joined to the surface on the one side of the element substrate 100. The liquid channels 125 (pressure chambers) that establish communication from the ink supply ports 116 of the element substrate 100 to the ejection nozzles 121 of the channel forming member 120 through the heating element side electrode portion 109a are formed between the element substrate 100 and the channel forming member 120. In the meantime, the channel forming members 120 include the multiple ejection nozzles 121 corresponding to the multiple resistance heating elements 105. Accordingly, the multiple liquid channels 125 partitioned so as to correspond to the respective resistance heating elements 105 are formed between the element substrate 100 and the channel forming member 120.

In the case where the resistance heating element 105 generates heat in a state where the ink flows from the ink supply port 116 into the liquid channel 125, the ink in contact with the heating element side electrode portion 109a in the vicinity of the resistance heating element 105 is heated to develop film-boiling, thus generating a bubble inside the liquid channel 125. This bubble ejects the ink in the vicinity of the ejection nozzle 121 out of the ejection nozzle 121, and the printing on the printing paper P (see FIG. 1) is thus carried out. Meanwhile, in the state where the ink flows into the liquid channel 125, the cleaning treatment for removing the kogation is carried out by applying a voltage between the heating element side electrode portion 109a and the counter electrode portion 109b of the second protection layer 109 from the outside through the electrode pad 111. In this instance, a surficial portion of the heating element side electrode portion 109a is eluted into the ink due to the electrochemical reaction, thus enabling the removal of the kogation adhering to the surface of the heating element side electrode portion 109a.

Here, the ink supplied from the ink container 20 to the printing unit 10 (see FIG. 2) flows into the liquid channels 125 from the ink supply ports 116 on one row out of the ink supply ports 116 arranged in two rows in the element substrate 100. The ink having flowed into the liquid channels 125 passes through the liquid channels 125 and flows out of the ink supply ports 116 on the other row out of the ink supply ports 116 arranged in the two rows. The ink having flowed out of the ink supply ports 116 on the other row flows into the liquid channels 125 again from the ink supply ports 116 on the one row. In this way, it is possible to circulate the ink supplied from the ink container 20. Accordingly, it is possible to suppress an increase in viscosity of the ink due to moisture desorption from the ejection nozzles 121, and to suppress a change in state of ejection of the ink due to the increase in viscosity of the ink.

In the present embodiment, the resistance heating elements 105 are formed at the surface of the insulation layer 104 on the opposite side of the first wiring layer 103. Accordingly, the first wiring layer 103 is electrically connected to the resistance heating elements 105 from a back face side, and electric wiring to be connected to a surface side of the resistance heating elements 105 therefore become unnecessary. In the case where the electric wiring is connected to the surface side of the resistance heating elements 105, a step corresponding to the thickness of the electric wiring in a range from 0.6 to 1.2 μm is formed at each portion of the first protection layer 108 covering the electric wiring. By forming the resistance heating elements 105 at the surface of the insulation layer 104 on the opposite side of the first wiring layer 103, the electric wiring to be connected to the surface side of the resistance heating elements 105 become unnecessary, and the step to be formed at the portion of the first protection layer 108 covering each resistance heating element 105 is therefore reduced. Accordingly, even in the case where the second protection layer 109 for removing the kogation is formed by using the material containing iridium, no conductive residues are generated at the side wall portions of the step to be formed at the portion of the first protection layer 108 covering each resistance heating element 105.

Unlike the first wiring layer 103, the second wiring layer 107 is not buried in the insulation layer 104. For this reason, a step corresponding to the thickness of the second wiring layer 107 in a range from 0.6 to 1.2 μm is formed at a portion of the first protection layer 108 covering the second wiring layer 107. In the case of forming the second protection layer 109 to overlap the first protection layer 108, the conductive residues RS not properly removed by the dry etching may be generated in some cases at the side wall portions of the step that is formed at the portion of the first protection layer 108 covering the second wiring layer 107. The counter electrode portion 109b of the second protection layer 109 is formed to overlap the portion of the first protection layer 108 covering the second wiring layer 107, and may therefore be electrically connected to the conductive residues RS generated at the side wall portions of the step based on the second wiring layer 107.

On the other hand, the heating element side electrode portion 109a of the second protection layer 109 is located away from the portion of the first protection layer 108 covering the second wiring layer 107, and is therefore not electrically connected to the conductive residues RS generated at the side wall portions of the step based on the second wiring layer 107. Meanwhile, the heating element side electrode portion 109a is formed to overlap the portion of the first protection layer 108 covering the resistance heating element 105, and can therefore extend to the electrode pad 111 along the flat portion of the first protection layer 108. Accordingly, the heating element side electrode portion 109a is electrically independent from the counter electrode portion 109b formed to overlap the portion of the first protection layer 108 covering the second wiring layer 107 and of the conductive residues RS generated at the side wall portions of the step based on the second wiring layer 107. In other words, the heating element side electrode portion 109a and the counter electrode portion 109b of the second protection layer 109 are not electrically connected through the conductive residues RS generated at the side wall portions of the step based on the second wiring layer 107.

Accordingly, even in the case where the conductive residues RS are generated at the side wall portions of the step based on the second wiring layer 107, it is possible to apply the voltage between the heating element side electrode portion 109a and the counter electrode portion 109b of the second protection layer 109 from the outside through the electrode pads 111. Moreover, since the surficial portion of the heating element side electrode portion 109a is eluted into the ink due to the electrochemical reaction, it is possible to remove the kogation adhering to surface of the heating element side electrode portion 109a. Thus, the kogation generated on the element substrate 100 can reliably be removed.

Meanwhile, unlike the first wiring layer 103, the second wiring layer 107 is not buried in the insulation layer 104. Accordingly, it is possible to reduce the number of times of chemical mechanical polishing (CMP) operations for planarizing the surface of the insulation layer 104. The reduction in the number of times of CMP operations makes it possible to suppress an increase in manufacturing cost of the element substrate 100 and of the liquid ejection head 1.

### <Method of Manufacturing Ink Jet Head Substrate>

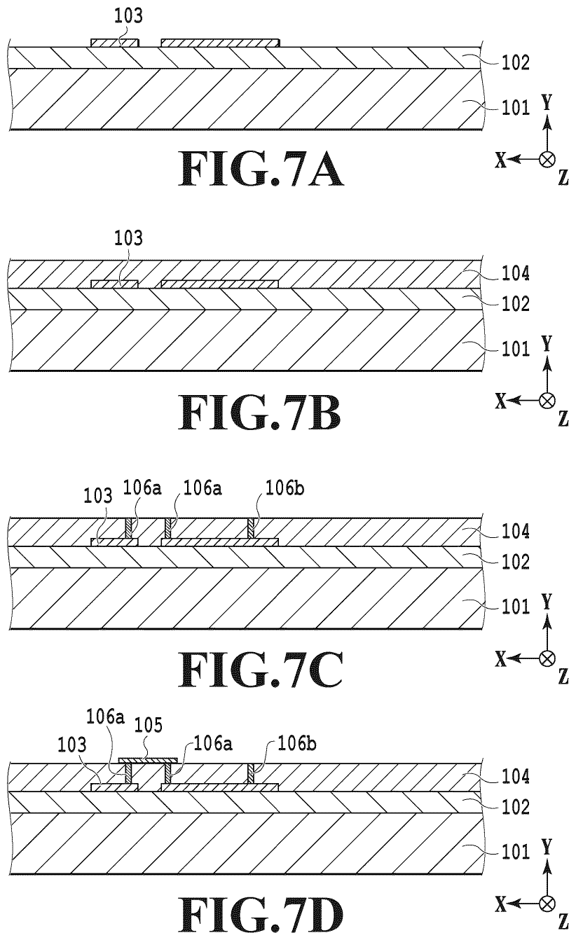

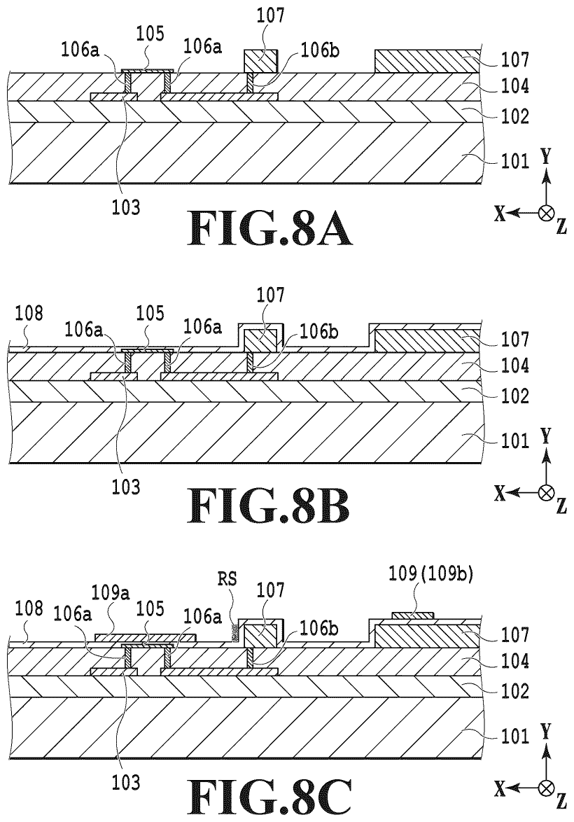

Next, a method of manufacturing the element substrate 100 (an ink jet head substrate) according to the first embodiment will be described with reference to FIGS. 7A to 8C. FIGS. 7A to 8C are schematic cross-sectional views for explaining manufacturing steps of the element substrate 100. The manufacturing steps of the element substrate 100 are shown in the order of FIG. 7A to 7D and FIGS. 8A to 8C. Here, in the manufacturing steps to be described below, the driving circuit (not shown) for selectively driving the resistance heating elements 105 is assumed to be formed in the silicon substrate 101 in advance. The driving circuit for selectively driving the resistance heating elements 105 is formed by using semiconductor elements such as switching transistors. FIGS. 7A to 8C simplify illustration of the silicon substrate 101 and omits illustration of the driving circuit.

First, as shown in FIG. 7A, the heat accumulation layer 102 is formed to overlap the surface on the one side (the +y direction side) of the silicon substrate 101. In the step of forming the heat accumulation layer 102, the heat accumulation layer 102 made of a thermally oxidized film using SiO₂ is formed by adopting a thermal oxidation method, a sputtering method, a chemical vapor deposition (CVD) method, and the like. Here, the heat accumulation layer 102 can be formed in the manufacturing process for forming the aforementioned driving circuit in the silicon substrate 101.

Next, the first wiring layer 103 is formed to overlap the surface on the one side of the heat accumulation layer 102. In the step of forming the first wiring layer 103, the first wiring layer 103 using aluminum as the material is formed by adopting the sputtering method. Then, the first wiring layer 103 is subjected to dry etching by adopting a photolithographic technique, and a cross-sectional shape as shown in FIG. 7A is obtained.

Next, as shown in FIG. 7B, the insulation layer 104 is formed to overlap the surfaces on the one side of the heat accumulation layer 102 and the first wiring layer 103. In the step of forming the insulation layer 104, the insulation layer 104 made of a silicon oxide film is formed by adopting the thermal oxidation method, the sputtering method, and the like. Then, the surface on the one side of the insulation layer 104 is planarized by the chemical mechanical polishing (CMP).

Next, as shown in FIG. 7C, the heat generation connecting members 106a, the wiring connecting member 106b, and the circuit connecting member (not shown) are formed in the insulation layer 104. In the step of forming the heat generation connecting members 106a, the wiring connecting member 106b, and the circuit connecting member, the insulation layer 104 is subjected to the dry etching by adopting the photolithographic technique, thus forming holes (not shown) in the insulation layer 104. Next, a tungsten film to close the holes formed to penetrate the insulation layer 104 is deposited by adopting a metal CVD method. Then, the heat generation connecting members 106a, the wiring connecting member 106b, and the circuit connecting member are formed in the holes penetrating the insulation layer 104 by removing unnecessary portions of the tungsten film by the chemical mechanical polishing (CMP).

Next, as shown in FIG. 7D, the resistance heating element 105 is formed at the portion on the surface on the one side of the insulation layer 104 to provide the heat generation connecting member 106a. In the step of forming the resistance heating element 105, the resistance heating element 105 using TaSiN as the material is formed by adopting a reactive sputtering method. Then, the resistance heating element 105 is subjected to the dry etching by adopting the photolithographic technique, thereby obtaining the cross-sectional shape as shown in FIG. 7D.

Next, as shown in FIG. 8A, the second wiring layer 107 is formed at the portion on the surface on the one side (the +y direction side) of the insulation layer 104 to provide the wiring connecting member 106b and the circuit connecting member (not shown). In the step of forming the second wiring layer 107, the second wiring layer 107 using aluminum as the material is formed by adopting the sputtering method. Then, the second wiring layer 107 is subjected to the dry etching by adopting the photolithographic technique, thereby obtaining the cross-sectional shape as shown in FIG. 8A.

Next, as shown in FIG. 8B, the first protection layer 108 is formed to overlap the surfaces on the one side of the insulation layer 104, the resistance heating element 105, and the second wiring layer 107. In the step of forming the first protection layer 108, the first protection layer 108 made of a silicon nitride film is formed by adopting a plasma CVD method.

Next, as shown in FIG. 8C, the second protection layer 109 is formed to overlap the surface on the one side of the first protection layer 108. In the step of forming the second protection layer 109, the second protection layer 109 using iridium as the material is formed by adopting the sputtering method. Then, the second protection layer 109 is subjected to the dry etching by adopting the photolithographic technique, thereby providing the second protection layer 109 with the heating element side electrode portion 109a and the counter electrode portion 109b. In this instance, the conductive residues RS not properly removed by the dry etching may be generated in some cases at the side wall portions of the step that is formed at the portion of the first protection layer 108 covering the second wiring layer 107. On the other hand, since the step formed at the portion of the first protection layer 108 covering each resistance heating element 105 is small, no conductive residues are generated at the side wall portions of the step on the first protection layer 108 based on the resistance heating element 105.

After the formation of the second protection layer 109, the electrode pads 111 are formed at the end portions of the second wiring layer 107 and so forth by gold plating and the like. In the step of forming the electrode pads 111, the metallic member 112a to electrically connect between the electrode pad 111a linked to the heating element side electrode portion 109a and the end portion of the heating element side electrode portion 109a is formed by gold plating and the like. Meanwhile, the metallic member 112b to electrically connect between the electrode pad 111b linked to the counter electrode portion 109b and the end portion of the counter electrode portion 109b is formed by gold plating and the like.

After the formation of the electrode pads 111, the ink supply ports 116 of the element substrate 100 are formed by adopting an anisotropic etching method, a sand blasting method, an anisotropic plasma etching method, and the like. Meanwhile, although detailed explanations will be omitted, the channel forming member 120 is formed on the surface on the one side of the element substrate 100 by adopting the photolithographic technique and the like. In this way, it is possible to manufacture the element substrate 100 that can reliably remove a kogation to be generated on the element substrate 100.

### EXAMPLE

Next, a specific example of the element substrate 100 according to the first embodiment will be described. The first wiring layer 103 was formed by using aluminum, and the thickness of the first wiring layer 103 was in a range of about 0.6 to 1.2 μm. Each resistance heating element 105 was formed by using a compound of tantalum such as TaSiN, and the thickness of the resistance heating element 105 was in a range of about 10 to 30 nm. The second wiring layer 107 was formed by using aluminum, and the thickness of the second wiring layer 107 was in a range of about 0.6 to 1.2 μm. The insulation layer 104 was formed by using a silicon oxide film. The heat generation connecting member 106a, the wiring connecting member 106b, and the circuit connecting member (not shown) were formed by using a tungsten film. The first protection layer 108 was formed by using a silicon nitride film, and the thickness of the first protection layer 108 was in a range of about 0.15 to 0.3 μm. The second protection layer 109 was formed by using iridium, and the thickness of the second protection layer 109 was in a range of about 0.2 to 0.3 μm.

As understood from the above description, the thickness of the resistance heating element 105 is smaller than the thickness of the second wiring layer 107. For this reason, the step to be formed at the portion of the first protection layer 108 covering the resistance heating element 105 has a negligibly small height. In the case of forming the heating element side electrode portion 109a and the counter electrode portion 109b of the second protection layer 109, no conductive residues were generated at the side wall portions of the step of the first protection layer 108 based on the resistance heating element 105. According to the present example, the kogation generated on the element substrate 100 could reliably be removed.

As described above, according to the first embodiment, it is possible to reliably remove a kogation generated on the element substrate 100. Specifically, in the present embodiment, the second protection layer 109 includes the heating element side electrode portion 109a that overlaps the portion of the first protection layer 108 covering the resistance heating element 105, and the counter electrode portion 109b that overlaps the portion of the first protection layer 108 covering the second wiring layer 107. As mentioned earlier, the heating element side electrode portion 109a of the second protection layer 109 is located away from the portion of the first protection layer 108 covering the second wiring layer 107, and is therefore not electrically connected to the conductive residues RS generated at the side wall portions of the step based on the second wiring layer 107. Accordingly, the heating element side electrode portion 109a and the counter electrode portion 109b of the second protection layer 109 are not electrically connected to each other through the conductive residues RS generated at the side wall portions of the step based on the second wiring layer 107. As a consequence, even in the case where the conductive residues RS are generated at the side wall portions of the step based on the second wiring layer 107, it is possible to apply the voltage between the heating element side electrode portion 109a and the counter electrode portion 109b of the second protection layer 109 from the outside through the electrode pads 111. Moreover, since the surficial portion of the heating element side electrode portion 109a is eluted into the ink due to the electrochemical reaction, the kogation adhering to the surface of the heating element side electrode portion 109a can reliably be removed. In this way, it is possible to reliably remove the kogation generated on the element substrate 100.

In the meantime, the multiple electrode pads 111 include the electrode pad 111a that is electrically connected to the end portion of the heating element side electrode portion 109a through the metallic member 112a, and the electrode pad 111b that is electrically connected to the end portion of the counter electrode portion 109b through the metallic member 112b. In this way, even in the case where the second protection layer 109 for removing the kogation is formed by using the material containing iridium and the like, the heating element side electrode portion 109a and the counter electrode portion 109b can easily be connected to the electrode pads 111.

Meanwhile, the heating element side electrode portion 109a and the counter electrode portion 109b are formed to extend along the direction of arrangement of the multiple resistance heating elements 105. Accordingly, the single electrode pad 111a to be linked to the heating element side electrode portion 109a can be used in common and the single electrode pad 111b to be linked to the counter electrode portion 109b can be used in common.

### Second Embodiment

Next, a second embodiment will be described. Since individual members in the second embodiment have the same configurations as those in the above-described first embodiment, these members will be explained by denoting the same reference signs as those of the respective members in the above-described first embodiment.

### <Configuration of Liquid Ejection Head Substrate>

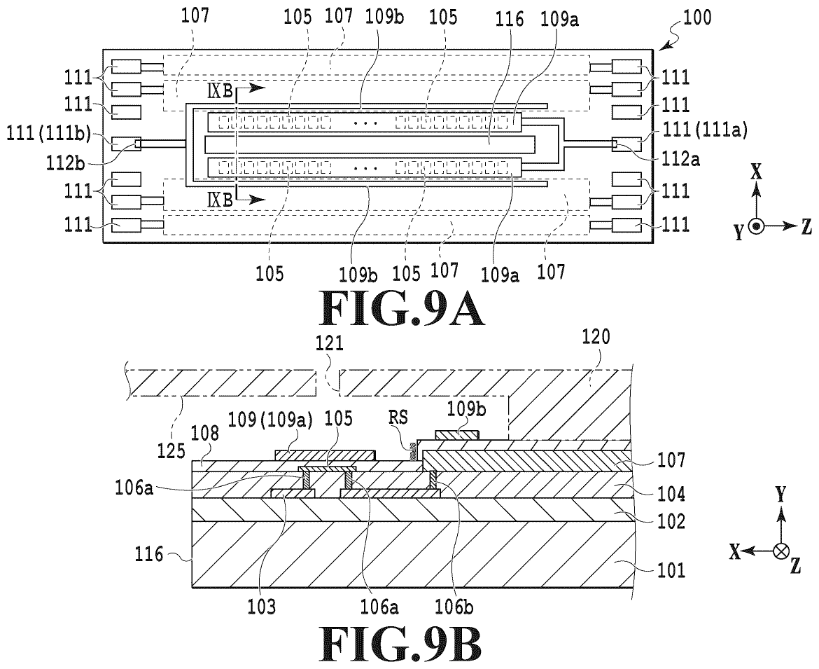

FIGS. 9A and 9B are diagrams schematically showing the element substrate 100 according to the second embodiment. FIG. 9A is a plan view schematically showing the element substrate 100. FIG. 9B is a schematic cross-sectional view taken along the IXB-IXB line in FIG. 9A. As shown in FIGS. 9A and 9B, the element substrate 100 according to the second embodiment includes the silicon substrate 101, the heat accumulation layer 102, the first wiring layer 103, the insulation layer 104, the resistance heating elements 105, and the second wiring layer 107 as with the first embodiment. Moreover, the element substrate 100 includes the heat generation connecting member 106a, the wiring connecting member 106b, the first protection layer 108, and the second protection layer 109 as with the first embodiment. The ink supply port 116 according to the second embodiment is formed to extend in an elongate shape in the longitudinal direction (the z direction) of the element substrate 100 at the central part of the element substrate 100. Meanwhile, the multiple resistance heating elements 105 are arranged in two lines in the longitudinal direction beside two sides (±x direction sides) of the ink supply port 116. The element substrate 100 according to the second embodiment is not provided with a mechanism for circulating the ink. Nonetheless, since the ink supply port 116 in the shape of the elongated hole does not require high accuracy of dimension, it is possible to reduce costs for forming the ink supply port 116 by adopting silicon wet etching and the like.

Here, a method of manufacturing the element substrate 100 according to the second embodiment is the same as that of the first embodiment, and detailed explanations will therefore be omitted. According to the second embodiment, it is possible to reliably remove a kogation generated at the element substrate 100 as with the first embodiment.

Meanwhile, the multiple electrode pads 111 include the electrode pad 111a that is electrically connected to the end portion of the heating element side electrode portion 109a through the metallic member 112a, and the electrode pad 111b that is electrically connected to the end portion of the counter electrode portion 109b through the metallic member 112b. In this way, even in the case where the second protection layer 109 for removing the kogation is formed by using the material containing iridium and the like, the heating element side electrode portion 109a and the counter electrode portion 109b can easily be connected to the electrode pads 111.

Meanwhile, the heating element side electrode portion 109a and the counter electrode portion 109b are formed to extend along the direction of arrangement of the multiple resistance heating elements 105. Accordingly, the single electrode pad 111a to be linked to the heating element side electrode portion 109a can be used in common and the single electrode pad 111b to be linked to the counter electrode portion 109b can be used in common.

In the respective embodiments described above, the heat generation connecting member 106a, the wiring connecting member 106b, and the circuit connecting member are formed by using the material containing tungsten. However, the present disclosure is not limited to this configuration. The heat generation connecting member 106a, the wiring connecting member 106b, and the circuit connecting member may be formed by using any of titanium (Ti), platinum (Pt), cobalt (Co), nickel (Ni), molybdenum (Mo), tantalum (Ta), and silicon (Si). The heat generation connecting member 106a, the wiring connecting member 106b, and the circuit connecting member may be formed by using a compound containing at least one of titanium, platinum, cobalt, nickel, molybdenum, tantalum, and silicon. Meanwhile, the heat generation connecting member 106a and the wiring connecting member 106b may be formed integrally with the first wiring layer 103. For example, the heat generation connecting member 106a and the wiring connecting member 106b integrated with the first wiring layer 103 may be formed by cutting out a portion of the first wiring layer 103 in the thickness direction. As mentioned above, the resistance heating elements 105 may be electrically connected directly to the first wiring layer 103. The second wiring layer 107 may be electrically connected directly to the first wiring layer 103.

In the respective embodiments described above, the first protection layer 108 is formed by using the silicon nitride film. However, the present disclosure is not limited to this configuration. For example, the first protection layer 108 may be formed by using a material containing SiO or SiC.

In the respective embodiments described above, an adhesion layer to enhance adhesion of the second protection layer 109 to the first protection layer 108 may be formed between the second protection layer 109 and the first protection layer 108. The adhesion layer may be formed by using a tantalum film.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, a kogation generated on a liquid ejection head substrate can reliably be removed.

This application claims the benefit of Japanese Patent Application No. 2024-130833, filed Aug. 7, 2024, which is hereby incorporated by reference herein in its entirety.

What is claimed is:

1. A liquid ejection head substrate comprising:
a first wiring layer for supplying electric power;
an insulation layer covering the first wiring layer;
a resistance heating element formed on a surface of the insulation layer on an opposite side of the first wiring layer and configured to generate thermal energy for ejecting a liquid by the electric power supplied from the first wiring layer;
a second wiring layer formed at a different portion from the resistance heating element on the surface of the insulation layer on the opposite side of the first wiring layer and electrically connected to the first wiring layer;
a first protection layer having an insulation property and covering the resistance heating element and the second wiring layer; and
a second protection layer formed to overlap the first protection layer, wherein the second protection layer includes
a heating element side electrode portion configured to overlap a portion of the first protection layer covering the resistance heating element, and
a counter electrode portion located away from the heating element side electrode portion and configured to overlap a portion of the first protection layer covering the second wiring layer.

2. The liquid ejection head substrate according to claim 1, further comprising:
a heat generation connecting member formed to penetrate the insulation layer and configured to electrically connect the first wiring layer to the resistance heating element; and
a wiring connecting member formed to penetrate the insulation layer and configured to electrically connect the first wiring layer to the second wiring layer.

3. The liquid ejection head substrate according to claim 2, wherein the heat generation connecting member and the wiring connecting member are formed by using a material containing tungsten.

4. The liquid ejection head substrate according to claim 1, wherein the second protection layer is formed by using a material containing a metal to be eluted into the liquid due to an electrochemical reaction.

5. The liquid ejection head substrate according to claim 4, wherein the metal contained in the material of the second protection layer is iridium.

6. The liquid ejection head substrate according to claim 4, further comprising:
a plurality of electrode pads electrically connected to outside, wherein
the plurality of electrode pads include an electrode pad electrically connected to an end portion of any of the heating element side electrode portion and the counter electrode portion through a metallic member using a metallic material being different from the material of the second protection layer.

7. The liquid ejection head substrate according to claim 6, wherein the metallic material contains gold.

8. The liquid ejection head substrate according to claim 1, wherein
a plurality of the resistance heating elements are arranged in at least one line, and
the heating element side electrode portion and the counter electrode portion are formed to extend along a direction of arrangement of the plurality of the resistance heating elements.

9. The liquid ejection head substrate according to claim 1, wherein a thickness of the resistance heating element is smaller than a thickness of the second wiring layer.

10. The liquid ejection head substrate according to claim 1, wherein the surface of the insulation layer on the opposite side of the first wiring layer is flat.

11. A liquid ejection head comprising:
a liquid ejection head substrate including
a first wiring layer for supplying electric power,
an insulation layer covering the first wiring layer,
a resistance heating element formed on a surface of the insulation layer on an opposite side of the first wiring layer and configured to generate thermal energy for ejecting a liquid by the electric power supplied from the first wiring layer,
a second wiring layer formed at a different portion from the resistance heating element on the surface of the insulation layer on the opposite side of the first wiring layer and electrically connected to the first wiring layer,
a first protection layer having an insulation property and covering the resistance heating element and the second wiring layer, and
a second protection layer formed to overlap the first protection layer; and
a channel forming member including an ejection nozzle for ejecting the liquid and configured to form a liquid channel between the channel forming member and the liquid ejection head substrate to communicate with the ejection nozzle, wherein
the second protection layer includes
a heating element side electrode portion configured to overlap a portion of the first protection layer covering the resistance heating element, and
a counter electrode portion located away from the heating element side electrode portion and configured to overlap a portion of the first protection layer covering the second wiring layer.

12. A method of manufacturing a liquid ejection head substrate comprising:
forming a first wiring layer for supplying electric power;
forming an insulation layer covering the first wiring layer;
forming a resistance heating element on a surface of the insulation layer on an opposite side of the first wiring layer so as to generate thermal energy for ejecting a liquid by the electric power supplied from the first wiring layer;
forming a second wiring layer at a different portion from the resistance heating element on the surface of the insulation layer on the opposite side of the first wiring layer so as to be electrically connected to the first wiring layer;
forming a first protection layer having an insulation property and covering the resistance heating element and the second wiring layer; and
forming a second protection layer so as to overlap the first protection layer, wherein
a heating element side electrode portion configured to overlap a portion of the first protection layer covering the resistance heating element, and a counter electrode portion located away from the heating element side electrode portion and configured to overlap a portion of the first protection layer covering the second wiring layer are formed in the forming a second protection layer.
